(19) United States
(12) Patent Application Publication
(10) Pub. No.: US 2003/0224845 A1
(43) Pub. Date: Dec. 4, 2003

(54) Symbol message cards

(75) Inventors: Robert P. Kogod, Arlington, VA (US); Robyn Cushing, New York, NY (US); David Derrick, Calfion, NJ (US); Bernice Kanner, New York, NY (US); Michael Kelley, Brewster, NY (US); Douglas Leeds, New York, NY (US); Robert Moehl, New York, NY (US); Andrew Sernovitz, New York, NY (US); William Zurynetz, Garfield, NJ (US)

Correspondence Address: COVINGTON & BURLING, ATTN: PATENT DOCKETING, 1201 PENNSYLVANIA AVENUE, N.W., WASHINGTON, DC, 20004-2401, US

(73) Assignee: c/o Charles E. Smith Management, Inc., Arlington, VA (US)

(21) Appl. No.: 10/299,013

(22) Filed: Nov. 19, 2002

Related U.S. Application Data
(63) Continuation-in-part of application No. 10/155,725, filed on May 28, 2002.

(51) Int. Cl. A63F 13/00

(52) U.S. Cl. 463/11

(57) ABSTRACT

The present invention provides a method for generating symbol messages, and particularly symbol messages using symbols for which efforts have been, are being, or will be made to increase their visibility and familiarity. Such symbols may include trademarks, registered trademarks, service marks, registered service marks, and other well-known symbols. Among other things, the present invention provides a method for generating a symbol or logo alphabet (or Logobet™) and a corresponding lexicon or grammar in which each letter corresponds to a recognized proprietary symbol likely to be associated with the respective letter. The present invention also provides apparatuses for generating such symbol messages and displays incorporating such symbol messages, particularly apparatuses and corresponding methods for playing card games based on the creation of symbol messages (e.g., a deck of cards such as LoGoFish™, in which proprietary symbols are depicted on the cards instead of numbers or suits).

This application is a continuation-in-part of co-pending U.S. patent application Ser. No. 10/155,725, filed May 28, 2002.

### FIELD OF THE INVENTION

The invention relates to symbol messages. More particularly, the invention relates to messages using symbols of increased visibility, familiarity and interest, and methods and apparatuses for creating such symbol messages. Even more particularly, the invention relates to playing cards and card games in which such symbols are used to create symbol messages.

### BACKGROUND OF THE INVENTION

Organizations and individuals generally value symbols, such as trademarks and service marks, associated with themselves and their goods and services. Entities are often eager to increase the visibility and familiarity of their symbols to consumers and often spend millions of dollars to this end. For example, companies spend tens of millions of dollars simply to associate their name or emblem with a professional sports stadium, a college football bowl game, or a particular message or slogan. Methods and apparatuses for creating symbol messages—particularly messages using symbols for which efforts have been, are being, or will be made to increase their visibility, familiarity, and interest—are desirable.

Some entities control businesses, properties, events, apparel, and other outlets useful for increasing the visibility and familiarity of symbols to consumers. For example, cities have roadside welcome signs; event organizers produce and sponsor events; and clothiers have t-shirts and other apparel. Symbol messages associated with or displayed in such outlets are a useful means for increasing the visibility and familiarity of the respective symbols. Such symbol messages also are useful for branding the corresponding outlets, branding an entity in connection with that outlet, and branding an entity as part of a symbol message. Methods and apparatuses for generating such symbol messages are desirable.

It is also recognized that many consumers like puzzles. Every year, consumers purchase many millions of dollars worth of puzzle-related games, books, and other products. Accordingly, there is an opportunity to capitalize on the consumer interest in puzzles and the interest of companies and individuals in increased visibility and familiarity for their symbols.

### SUMMARY OF THE INVENTION

The following features are present in some, but not necessarily all, embodiments of the present invention.

A feature of the present invention is to provide a method for generating a symbol alphabet in which each letter of the alphabet corresponds to a recognized proprietary symbol likely to be associated with the respective letter. Such symbol alphabets may then be used to form a symbol lexicon. FIG. 1A depicts an example of an alphabet of the present invention. FIG. 1A depicts an alphabet 101 and a corresponding symbol alphabet 102. In the embodiment depicted in FIG. 1A, each symbol in symbol alphabet 102 is a corporate logo or trademark. The owner of each registered trademark is identified in the Brief Description of the Drawings. FIG. 1B and FIG. 1C depict messages generated using the logo alphabet, or Logobet™, created in accordance with the present invention.

Another feature of the present invention is to provide a method for generating a symbol message corresponding to a city name, in which each letter (or group of letters) in the name is replaced by a recognized proprietary symbol likely to be associated with the respective letter (or group of letters). FIG. 2A and FIG. 2B depict an example of a display of the present invention. FIG. 2A depicts a t-shirt bearing the message 201 “I LOVE MEMPHIS.” FIG. 2B depicts a t-shirt bearing a display including a symbol message 202 corresponding to the message 201. In the symbol message 202, the words “I” and “MEMPHIS” are replaced by corresponding symbol words 203 and 204 comprising well-known registered trademarks. The owner of each registered trademark is identified in the Brief Description of the Drawings.

More broadly, a feature of the invention is to provide a method for generating a symbol message.

Another feature of the invention is to provide a method for generating a symbol message using symbols for which efforts have been, are being, or will be made to increase their visibility and familiarity. Such symbols may include trademarks, registered trademarks, service marks, registered service marks, and other well-known symbols.

A further feature of the invention is to provide a method for generating a symbol message from a selected message.

A feature of the invention is to provide a method for generating a symbol message from selected characters.

Another feature of the present invention is to provide a method for generating a symbol message from a selected core set of message characters.

A further feature of the invention is to provide a method for generating a grammar comprising symbols.

A feature of the present invention is to provide an apparatus that implements any or all of the methods of the present invention.

A feature of the invention is to provide an apparatus for generating a symbol message using symbols for which efforts have been, are being, or will be made to increase their visibility and familiarity. Such symbols may include trademarks, registered trademarks, service marks, registered service marks and other well-known marks.

A feature of the present invention is to provide a display through the implementation of any or all of the methods of the present invention.

A further feature of the present invention is to provide a display using symbols for which efforts have been, are being, or will be made to increase their visibility and familiarity.

An embodiment of a method of the present invention includes (i) dividing a message into at least one message subset (and optionally at least two message subsets), (ii) associating a symbol with each message subset, and (iii) replacing each message subset with the associated symbol.

An alternative embodiment of a method of the present invention includes (i) dividing a plurality of characters into at least one character subset (and optionally at least two character subsets), (ii) associating a symbol with at least one of the character subsets, and (iii) generating a message comprising the associated symbol.

An alternative embodiment of a method of the present invention includes (i) dividing a core set of message characters into at least one message subset (and optionally at least two message subsets), (ii) displaying each message subset, (iii) associating each message subset with at least one target symbol, (iv) selecting one associated target symbol for each message subset, (v) replacing each message subset with the selected target symbol, and (vi) displaying each selected target symbol.

An alternative embodiment of a method of the present invention includes (i) generating at least one character subset from a set of characters, (ii) generating a set of symbols, (iii) generating, for each character subset, an association with a symbol subset, and (iv) generating a lexicon comprising each association.

An embodiment of an apparatus of the present invention is a set of playing cards depicting symbols drawn from trademarks, registered trademarks, service marks, registered service marks, well-known marks, and other proprietary symbols instead of or in addition to the ordinary numbers and suits. In some embodiments, the playing cards may include rules for games based on grouping cards by (i) commonality of symbol, (ii) commonality of associated alphanumeric characters, phonemes, words, or ideographs, or (iii) ability to form a symbol message using the symbols depicted on the grouped cards.

An alternative embodiment of a method of the present invention is a method of playing games using playing cards depicting symbols drawn from trademarks, registered trademarks, service marks, registered service marks, well-known marks, and other proprietary symbols, instead of or in addition to the ordinary numbers and suits, by grouping cards according to (i) commonality of symbol, (ii) commonality of associated alphanumeric characters, phonemes, words, or ideographs, or (iii) ability to form a symbol message using the symbols depicted on the grouped cards.

An alternative embodiment of an apparatus of the present invention includes (i) an input device configured to receive a message, (ii) a visual display, (iii) a memory device configured to receive and store information, and (iv) a microprocessor in communication with the memory device, the input device, and the visual display. The apparatus is configured to implement, and to permit a user to implement, any or all of the methods of the present invention.

An embodiment of a design or a display of the present invention includes a plurality of symbols corresponding to selected portions of a message.

An embodiment of a design or a display of the present invention includes a plurality of symbols corresponding to selected characters.

Another embodiment of a design or a display of the present invention includes a plurality of symbols corresponding to a selected core set of message characters.

In embodiments of the present invention, the symbols are trademarks, registered trademarks, service marks, registered service marks, well-known marks, or other proprietary symbols.

Additional objects and advantages of the invention are set forth in part in the description which follows, and in part are apparent from the description, or may be learned by practice of the invention. The objects and advantages of the invention may also be realized and attained by means of the instrumentalities and combinations particularly set out in the appended claims.

### BRIEF DESCRIPTION OF THE DRAWINGS

The accompanying drawings, which are incorporated in and constitute part of the specification, illustrate preferred embodiments of the invention, and together with the description, serve to explain the principles of the invention.

FIG. 1A is an example of a lexicon—using a symbol alphabet—generated according to the embodiment depicted in FIG. 3. FIG. 1A depicts the following registered trademarks: a registered trademark symbol 102(a) associated with and owned by American Telephone and Telegraph Co., 550 Madison Avenue, New York, N.Y. 10022; a registered trademark symbol 102(b) associated with and owned by BellSouth Intellectual Property Corp., 824 Market Street, Suite 510, Wilmington, Del. 19801; a registered trademark symbol 102(c) associated with and owned by Coca-Cola Co., One Coca-Cola Plaza, Atlanta, Ga. 30313; a registered trademark symbol 102(d) associated with and owned by Delta Air Lines, Inc., Atlanta Airport, Atlanta, Ga.; a registered trademark symbol 102(e) associated with and owned by Estee Lauder, Inc., 747 5th Avenue, New York, N.Y. 10019; a registered trademark symbol 102(f) associated with Foot Locker and owned by Venator Group Retail, Inc., 112 West 34th Street, New York, N.Y. 10120; a registered trademark symbol 102(g) associated with and owned by General Electric Corp., One River Road, Schenectady, N.Y. 12345; a registered trademark symbol 102(h) associated with and owned by Hilton Hotels Corp., 9336 Civic Center Dr., Beverly Hills, Calif. 90210; a registered trademark symbol 102(i) associated with Infiniti and owned by Nissan Motor Co., Ltd., No.2 Takaracho, Kanagawa-ku, Yokohama-shi, Kanagawa-ken, Japan; a registered trademark symbol 102(j) associated with and owned by J. P. Morgan Chase & Co., 270 Park Avenue, New York, N.Y. 10017; a registered trademark symbol 102(k) associated with Kmart and owned by S. S. Kresge Co., 2727 2nd Avenue, Detroit, Mich. 48232; a registered trademark symbol 102(l) associated with and owned by Lucent Technologies Inc., 600 Mountain Avenue, Murray Hill, N.J. 07974; a registered trademark symbol 102(m) associated with and owned by McDonald's Corp., One McDonald's Plaza, Oak Brook, Ill. 60523; a registered trademark symbol 102(n) associated with and owned by Nike, Inc., One Bowerman Drive, Beaverton, Oreg. 97005; a registered trademark symbol 102(o) associated with Oldsmobile and owned by General Motors Corp., 300 Renaissance Center, P.O. Box 300, Detroit, Mich. 48265; a registered trademark symbol 102(p) associated with and owned by Pepsico, Inc., 700 Anderson Hill Road, Purchase, N.Y. 10577; a registered trademark symbol 102(q) associated with and owned by Qwest Communications International Inc., 555 Seventeenth Street, Suite 1000, Denver, Colo. 80202; a registered trademark symbol 102(r) associated with and owned by Reebok International Limited, Moor Lane Mill, Moor Lane, Lancaster LA1 1GF, ENGLAND; a registered trademark symbol 102(s) associated with and owned by Safeway Stores, Inc., Fourth and Jackson Streets, Oakland, Calif. 94660; a registered trademark symbol 102(t) associated with and owned by Target Brands, Inc., 1000 Nicollett Ave., TPS 1365, Minneapolis, Minn. 55403; a registered trademark symbol 102(u) associated with and owned by United Air Lines, Inc., P.O. Box 66100, Chicago, Ill. 60666; a registered trademark symbol 102(v) associated with and owned by Volkswagen Aktiengesellschaft Co., Wolfsburg, Fed. Rep. Germany; a registered trademark symbol 102(w) associated with and owned by Whirlpool Properties, Inc., 500 Renaissance Drive, Suite 101, St. Joseph, Mich. 49022; a registered trademark symbol 102(x) associated with and owned by Xerox Corp., 800 Long Ridge Road, Stamford, Conn. 06904; a registered trademark symbol 102(y) associated with and owned by National Yellow Pages Service Agency, Inc., 10700 Meridian Avenue North, Suite 201, Seattle, Wash. 98133; and a registered trademark symbol 102(z) associated with and owned by Zenith Electronics Corp., 1000 Milwaukee Avenue, Glenview, Ill. 60025.

FIG. 1B is an example of a symbol message created by using the lexicon depicted in FIG. 1A. The symbol message depicted in FIG. 1B comprises registered trademark symbols 102(a), (e), (f), (g), (i), (l), (n), (o), (r), (s), and (v) of FIG. 1A.

FIG. 1C is another example of a symbol message created by using the lexicon depicted in FIG. 1A. The symbol message depicted in FIG. 1C comprises registered trademark symbols 102(a), (b), (d), (h), (i), (p), (r), (t), and (y) of FIG. 1A.

FIG. 2A and FIG. 2B, respectively, depict an example of a t-shirt bearing a selected message and a t-shirt bearing an embodiment of a display of the present invention corresponding to the selected message. Symbol message 202 in FIG. 2B comprises the following registered trademarks: a registered trademark symbol 203 and 210 associated with Infiniti and owned by Nissan Motor Co., Ltd., No.2 Takaracho, Kanagawa-ku, Yokohama-shi, Kanagawa-ken, Japan; a registered trademark symbol 205 and 207 associated with and owned by Motorola, Inc., 1303 East Algonquin Road, Schaumburg, Ill. 60196; a registered trademark symbol 206 associated with and owned by Estee Lauder, Inc., 747 5th Avenue, New York, N.Y. 10019; a registered trademark symbol 208 associated with and owned by associated with and owned by Pepsico, Inc., 700 Anderson Hill Road, Purchase, N.Y. 10577; a registered trademark symbol 209 associated with and owned by Hilton Hotels Corp., 9336 Civic Center Dr., Beverly Hills, Calif. 90210, and a registered trademark symbol 211 associated with and owned by Sprint Communications Co., 6480 Sprint Parkway, Overland Park, Kans. 66251.

FIG. 3 is a flow chart depicting an embodiment of the present invention in which a lexicon of associations is generated between certain character subsets and certain symbol subsets.

FIG. 4 is a flow chart depicting an embodiment of the present invention in which a message is divided into at least one message subset.

FIG. 5 is an example of a symbol message generated according to the embodiment depicted in FIG. 4. FIG. 5. depicts a registered trademark symbol 505 associated with and owned by Chick-Fil-A, Inc., 535 Central Avenue, Suite 102, Hapeville, Ga. 30054, and a registered trademark symbol 506 associated with and owned by Apple Computer, Inc., 1 Infinite Loop, Cupertino, Calif. 95014. These registered trademark symbols also appear in symbol message 508.

FIG. 6 is a flow chart depicting another embodiment of the present invention in which a plurality of characters is divided into at least one character subset.

FIG. 7 is an example of a symbol message generated according to the embodiment depicted in FIG. 6. FIG. 7 depicts the following registered trademarks: a registered trademark symbol 709 associated with and owned by Nike, Inc., One Bowerman Drive, Beaverton, Oreg. 97005; a registered trademark symbol 710 associated with and owned by Estee Lauder, Inc., 747 5th Avenue, New York, N.Y. 10019; a registered trademark symbol 711 associated with and owned by Weyerhaeuser Co., Tacoma, Wash., 98477; a registered trademark symbol 712 associated with and owned by National Yellow Pages Service Agency, Inc., 10700 Meridian Avenue North, Suite 201, Seattle, Wash. 98133; a registered trademark symbol 713 associated with Oldsmobile and owned by General Motors Corp., 300 Renaissance Center, P.O. Box 300, Detroit, Mich. 48265; a registered trademark symbol 714 associated with and owned by Reebok International Limited, Moor Lane Mill, Moor Lane, Lancaster LA1 1GF, ENGLAND; and a registered trademark symbol 715 associated with Kmart and owned by S. S. Kresge Co., 2727 2nd Avenue, Detroit, Mich. 48232. These registered trademark symbols also appear in symbol message 716.

FIG. 8 is a flow chart depicting yet another embodiment of the present invention in which a core set of message characters is divided into at least one message subset.

FIG. 9 is an example of a symbol message generated according to the embodiment depicted in FIG. 8. FIG. 9 depicts the following registered trademarks: a registered trademark symbol 910 and 914 associated with and owned by Mercedes-Benz Aktiengesellschaft, 136 Mercedes Strasse, 7000 Stuttgart 60 (Unterturkheim), Fed. Rep. Germany; a registered trademark symbol 911 and 915 associated with and owned by McDonald's Corp., One McDonald's Plaza, Oak Brook, Ill. 60523; a registered trademark symbol 912 and 916 associated with and owned by Motorola, Inc., 1303 East Algonquin Road, Schaumburg, Ill. 60196; a registered trademark symbol 913 associated with and owned by Estee Lauder, Inc., 747 5th Avenue, New York, N.Y. 10019; a registered trademark symbol 917 associated with and owned by Pepsico, Inc., 700 Anderson Hill Road, Purchase, N.Y. 10577; a registered trademark symbol 918 associated with and owned by Hilton Hotels Corp., 9336 Civic Center Dr., Beverly Hills, Calif. 90210; a registered trademark symbol 919 associated with Infiniti and owned by Nissan Motor Co., Ltd., No.2 Takaracho, Kanagawa-ku, Yokohama-shi, Kanagawa-ken, Japan; and a registered trademark symbol 920 associated with and owned by Sprint Communications Co., 6480 Sprint Parkway, Overland Park, Kans. 66251. These registered trademark symbols, with the exception of registered trademark symbol 910 and 914 associated with and owned by Mercedes-Benz Aktiengesellschaft, also appear in symbol message 924.

FIG. 10 depicts an embodiment of an apparatus for playing a game according to the present invention. FIG. 10 depicts the following registered trademarks: a registered trademark symbol associated with and owned by Delta Air Lines, Inc., Atlanta Airport, Atlanta, Ga.; a registered trademark symbol associated with and owned by Ford Motor Company, The American Road, Dearborn, Mich. 48121; a registered trademark symbol associated with and owned by Apple Computer, Inc., 1 Infinite Loop, Cupertino, Calif. 95014; a registered trademark symbol associated with and owned by American Airlines, M.D. 5675, P.O. Box 619696, Dallas Fort Worth Airport, TX 762619616; a registered trademark symbol associated with and owned by Hewlett-Packard Company, 3000 Hanover Street, Palo Alto, Calif. 94304; a registered trademark symbol associated with and owned by Oracle International Corporation, 500 Oracle Parkway, Redwood City, Calif. 94065; a registered trademark symbol associated with and owned by; a registered trademark symbol associated with and owned by Mercedes-Benz Aktiengesellschaft, 136 Mercedes Strasse, 7000 Stuttgart 60 (Unterturkheim), Fed. Rep. Germany; and a registered trademark symbol associated with and owned by Enterprise Rent-A-Car Company, 8850 Ladue Road, St. Louis, Mo. 63124.

FIG. 11 is a diagram depicting embodiments of an apparatus for generating symbol messages, grammars or lexicons, including for playing a game according to the present invention.

### DETAILED DESCRIPTION

Visual messages generally are composed of one or more characters or symbols. The characters or symbols may include alphanumeric characters, phonemes, ideographs, pictographs, hieroglyphs, and other forms of visual communication.

The present invention generates visual messages using symbols or symbol alphabets. In some embodiments, the symbols are trademarks, registered trademarks, service marks, registered service marks, well-known marks or symbols, logos or other proprietary symbols. As used in this specification, a well-known mark or symbol is one whose meaning or association is understood or recognized by a segment of the public. A well-known mark includes, but is not limited to, famous trademarks that may be protected under anti-dilution laws. For purposes of this specification, a well-known mark or symbol includes, as another example, marks or symbols that have acquired secondary meaning in a geographic area.

The symbol messages or symbol alphabets according to the present invention—when comprising logos or other similar well-known marks or symbols—are useful for, among other things, increasing the visibility and familiarity of the incorporated symbols. They also are useful for branding the corresponding outlets, branding an entity in connection with that outlet, and branding an entity as part of a symbol message. Such symbol messages or symbol alphabets may be displayed on or in, for example, billboards, print or electronic media, clothing, accessories, or novelty items.

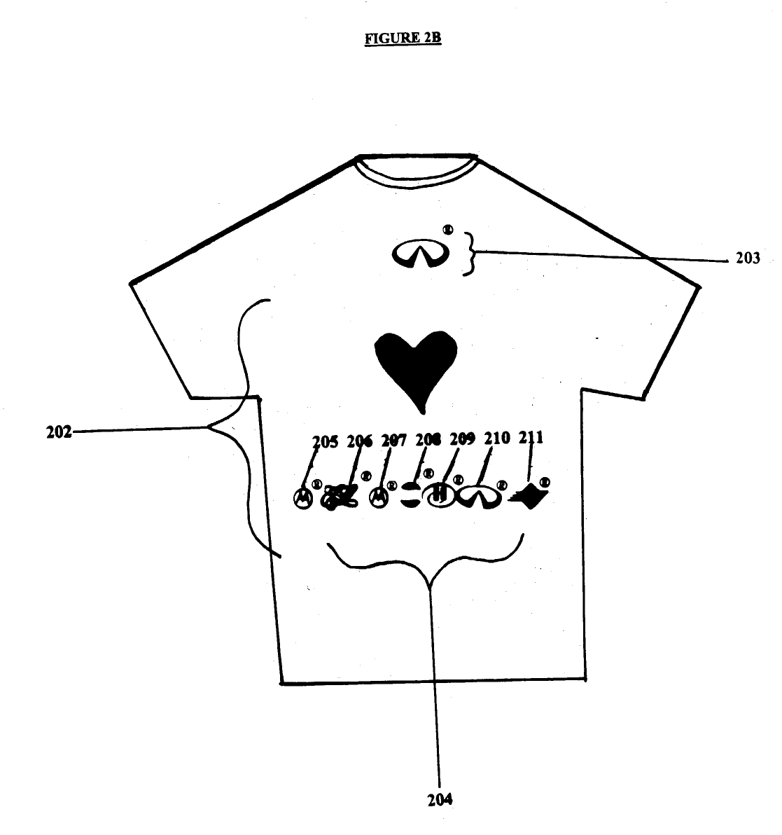

FIG. 3 depicts a flow chart of an embodiment of the present invention. The embodiment depicted in FIG. 3 comprises four steps for generating a grammar comprising symbols:

Generate At Least One Character Subset From A Set Of Characters step 301;

Generate A Set of Symbols step 302;

Generate Associations Between Each Character Subset And A Symbol Subset Of The Set Of Symbols step 303; and

Generate A Lexicon Comprising The Associations step 304.

Steps 301 and 302, respectively, comprise generating at least one character subset from a set of characters and generating a set of symbols. The set of characters comprises characters from existing grammars. For example, the set of characters might be the English alphabet and related phonemes, Egyptian hieroglyphs, or Arabic numerals. The set of symbols might be all trademarks, registered trademarks, service marks, registered service marks, or well-known marks.

Step 303 of the embodiment depicted in FIG. 3 involves generating associations between each character subset and symbol subsets of the set of symbols. The associations preferably are made according to existing relationships—such as visual similarities, phonetic similarities, common initial sounds or characters, or common target audience associations—between the characters and the symbols as described in this specification or as is apparent in view of this specification to one of skill in the art. For example, a character subset may comprise letters from the English alphabet, and symbol subsets may comprise professional sports team emblems. Each team emblem may be associated with the letter corresponding to the first letter of the team name.

In the embodiment depicted in FIG. 3, step 304 follows step 303. Step 304 comprises generating a lexicon using the associations generated in step 303. For example, words and phrases may be generated by replacing each letter with the symbol associated with that letter.

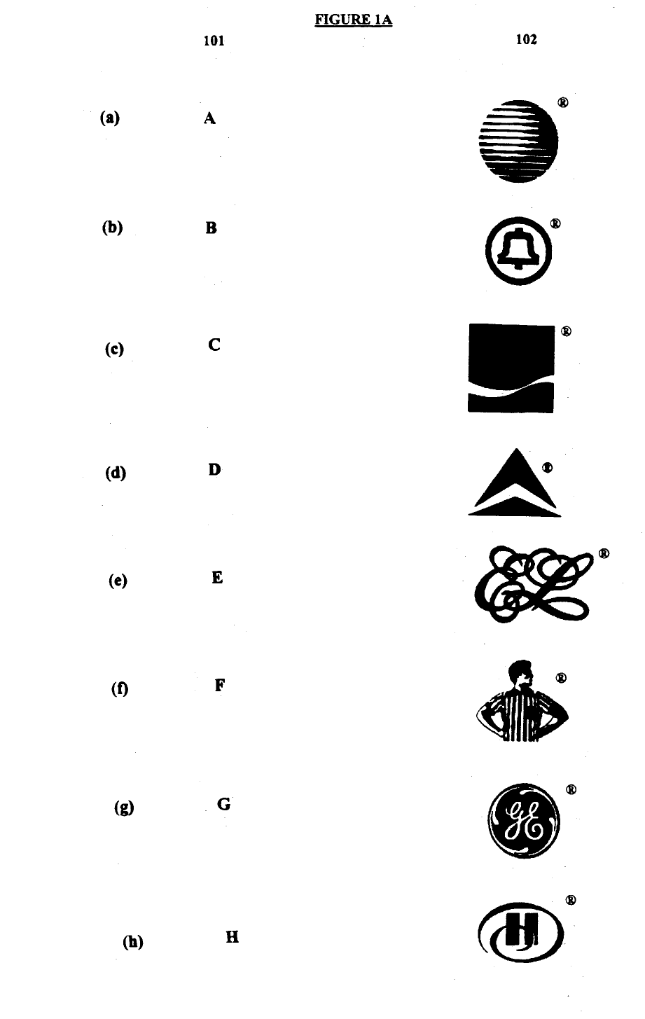

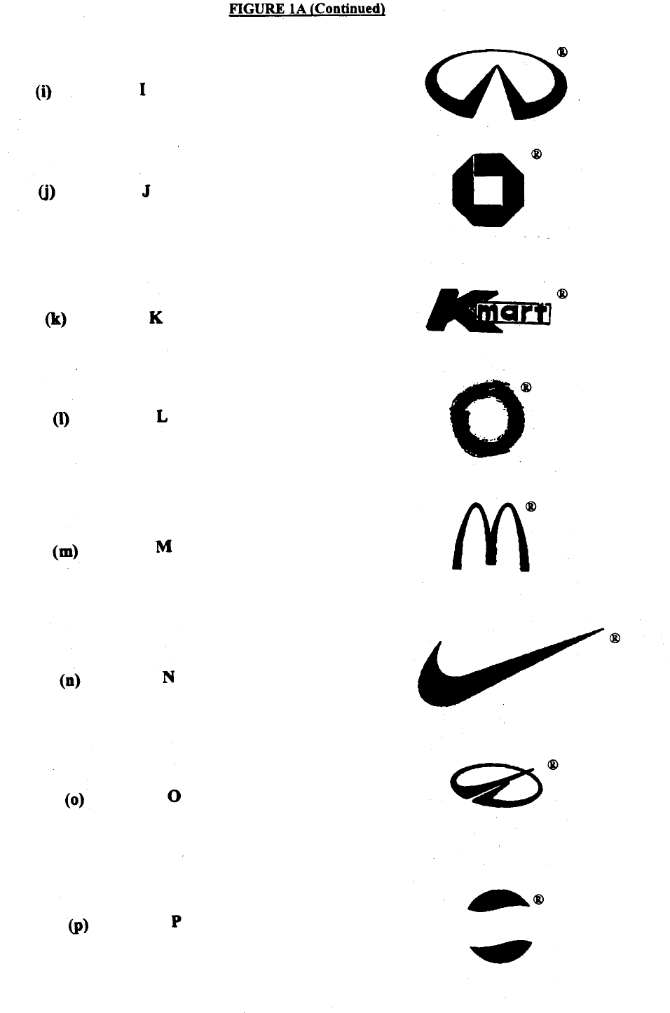

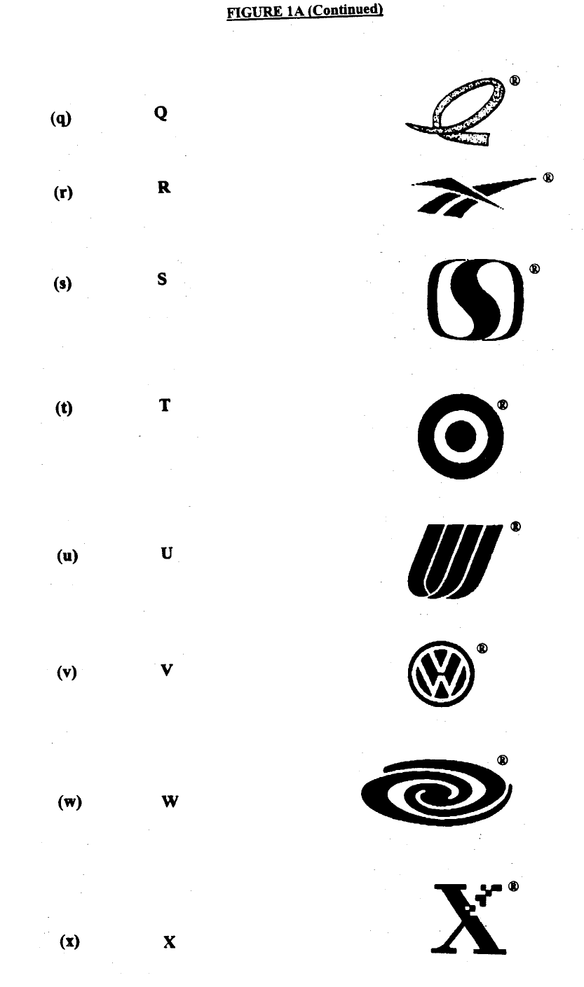

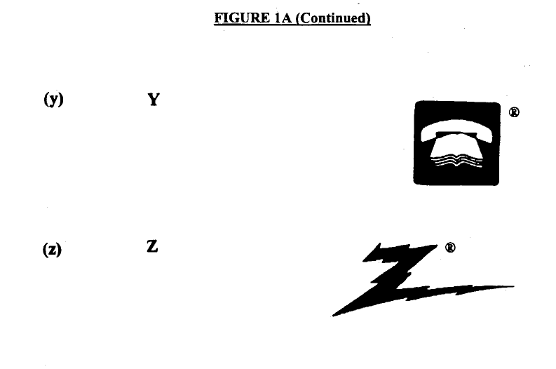

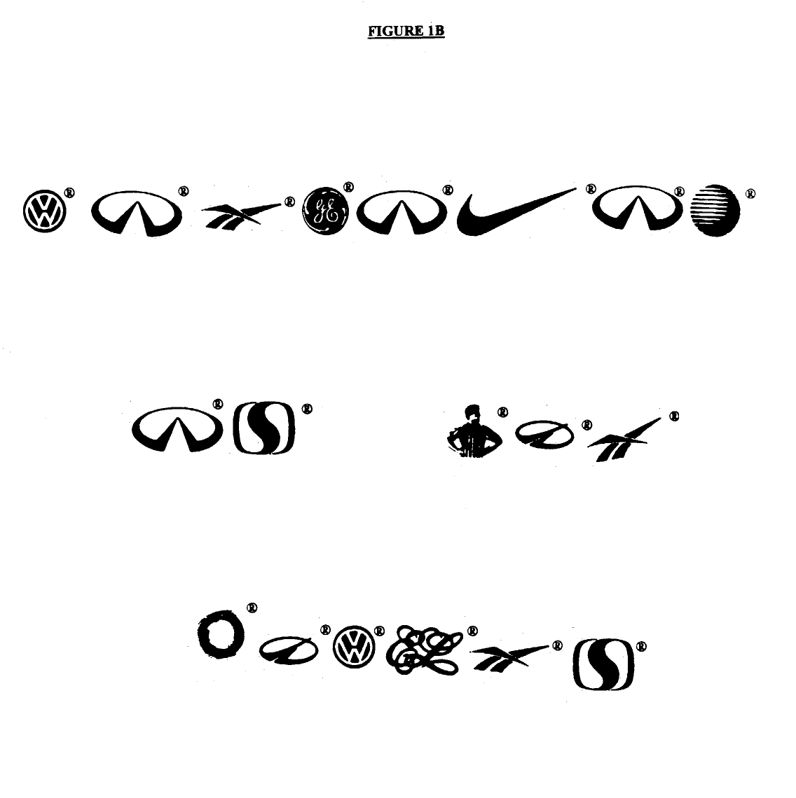

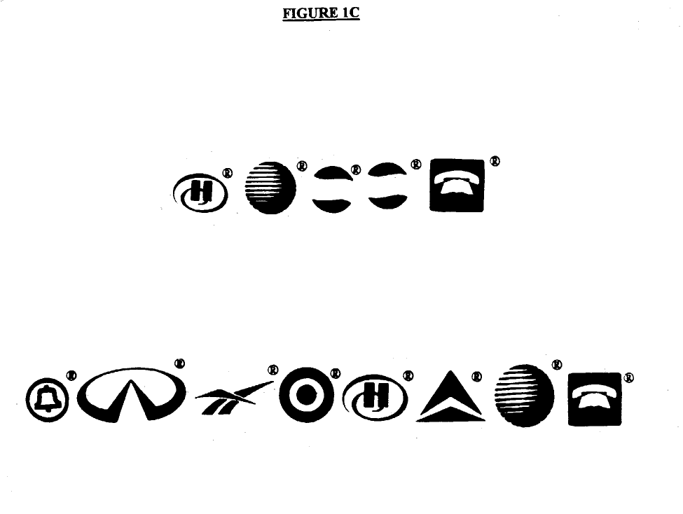

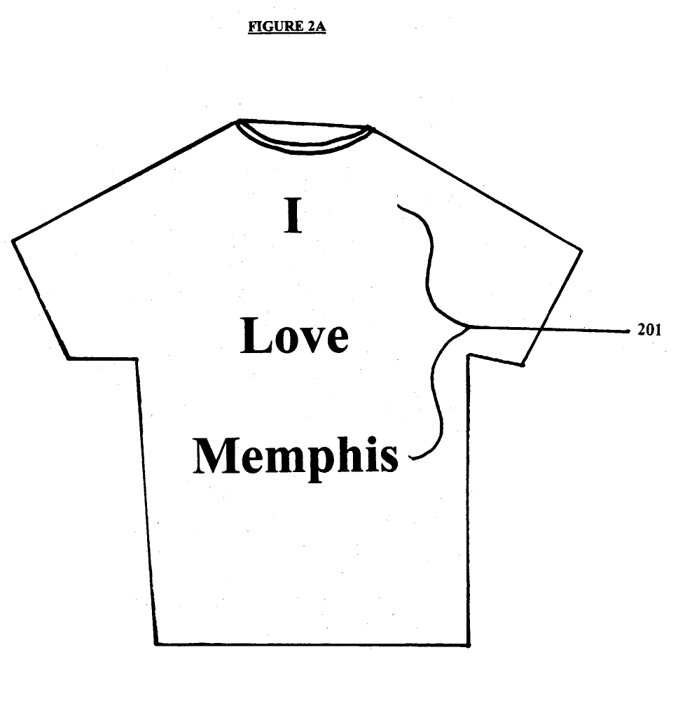

FIG. 1A depicts an example of a lexicon of the present invention, which lexicon was created using the embodiment of FIG. 3. FIG. 1A shows a set of characters 101 and a set of symbols 102 that have been generated. In this example, the character subset comprises the set of characters of the English alphabet, and the symbol associated with each character is a registered trademark. The associations between the two subsets are shown by designations (a) through (z). In this embodiment, these associations generate a symbol alphabet, which are used to generate a lexicon. For example, FIG. 1B shows a symbol message corresponding to the slogan “VIRGINIA IS FOR LOVERS”®, and FIG. 1C shows a symbol message corresponding to the phrase “HAPPY BIRTHDAY.” In other embodiments (not depicted), the characters may include words, phonemes, ideographs or other visual marks or depictions; the symbols may include service marks or other well-known symbols, marks or depictions; and there may be more than one symbol associated with one or more of the character subsets.

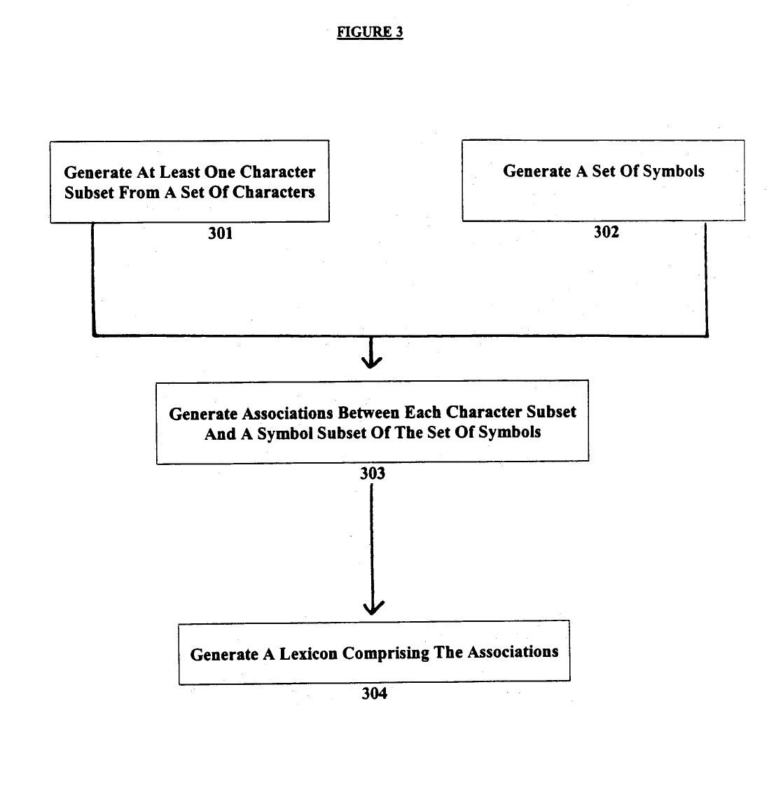

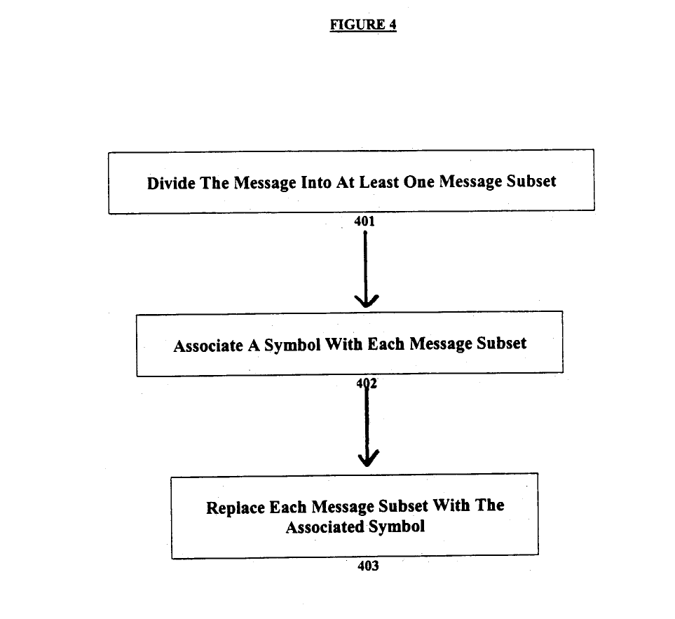

FIG. 4 depicts a flow chart of an embodiment of a method of the present invention. This embodiment comprises three steps for generating a symbol message from a selected message:

Divide The Message Into At Least One Message Subset step 401;

Associate A Symbol With Each Message Subset step 402; and

Replace Each Message Subset With The Associated Symbol step 403.

Step 401 comprises dividing a selected message into one or more message subsets. A message subset may comprise the entire message or some smaller portion of the message (for example, a syllable). If more than one message subset is formed, the message subsets may be the same or different in size. For example, if the message is a word, certain message subsets may include a syllable, and other message subsets may include only a letter.

Step 402 of the embodiment depicted in FIG. 4 comprises associating a symbol with each message subset. In other words, in the embodiment depicted in FIG. 4, each message subset is assigned a symbol. The symbols preferably are trademarks, registered trademarks, service marks, registered service marks, well-known marks, or other proprietary symbols. These symbols optionally are associated with message subsets based on existing or apparent relationships or associations—such as visual similarities, phonetic similarities, common initial characters or sounds, or common target audience associations—between each message subset and each corresponding symbol. For example, if the message is a word and if the word is divided into its letters in step 401, each letter may be assigned a symbol that the target audience associates with a company name beginning with the same letter. Moreover, the same symbol preferably is associated with each message subset having the same value. Thus, in some embodiments, the same letters in a word may be assigned the same symbols.

Step 402 may be implemented before or after step 401. For example, one may first associate symbols with a variety of possible message subsets for a variety of possible messages and then divide the selected message into message subsets that have already been associated with symbols. Alternatively, one may select a message, divide that message into message subsets, and then associate symbols with those message subsets.

Step 403 of the embodiment depicted in FIG. 4 comprises replacing each message subset with the associated symbol. Step 403 follows steps 401 and 402 and converts the selected message to a corresponding symbol message by replacing part or all of the message with symbols.

FIG. 5 depicts an example of the embodiment of the present invention depicted in FIG. 4. In this example, the message 501 is the word “CHICAGO.” This message is divided into three message subsets 502, 503, and 504: “CHIC,” “A,” and “GO.” According to step 502 depicted in FIG. 4, each message subset is then associated with a respective symbol 505, 506 and 507. “CHIC” 502 is associated with a registered trademark symbol 505 associated with Chick-Fil-A, Inc. “A” 503 is associated with a registered trademark symbol 506 associated with Apple Computer, Inc. “GO” 504 is associated with a stoplight symbol 507 with the green light turned on. Then each message subset 502, 503, and 504 is replaced with its respective associated symbol 505, 506 and 507, thus yielding the final symbol message 508.

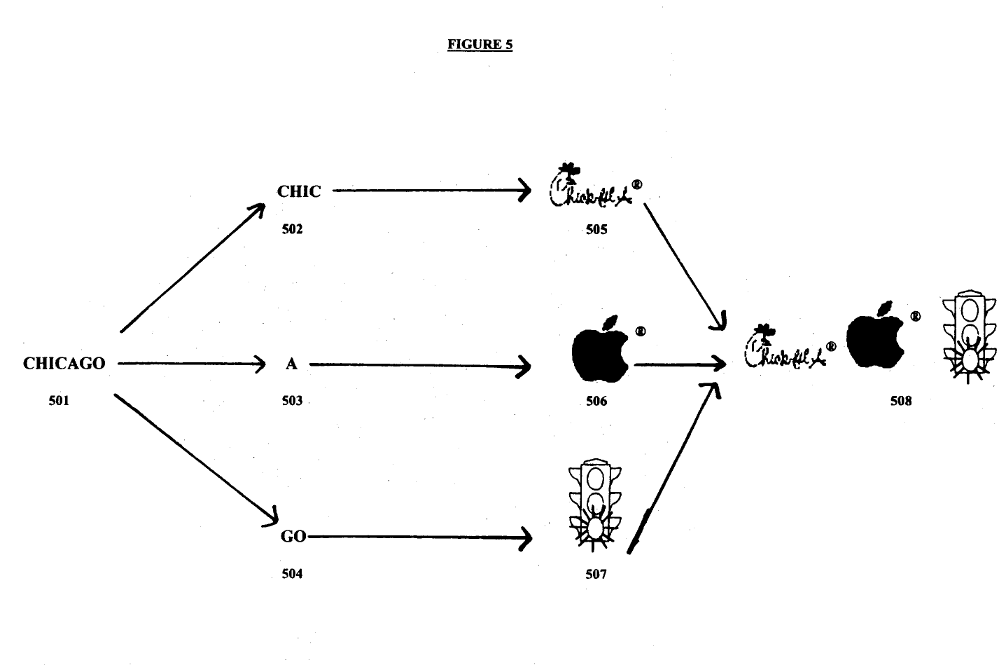

FIG. 6 depicts a flow chart of another embodiment of a method of the present invention. The embodiment depicted in FIG. 6 comprises three steps for generating a symbol message from a selected plurality of characters:

Divide A Plurality of Characters Into At Least One Character Subset step 601;

Associate A Symbol With Each Of The Character Subsets step 602; and

Generate A Message Comprising Each Associated Symbol step 603.

Step 601 comprises dividing a plurality of characters into one or more character subsets. Each character subset may be one or more alphanumeric characters, phonemes, words, ideographs, or any other visual mark or symbol. For example, a plurality of characters could be a name, and that name could be divided into character subsets, with some subsets including a letter and other subsets including a phoneme. As another example, the plurality of characters could be an abbreviation.

Step 602 of the embodiment depicted in FIG. 6 comprises associating a symbol with each of the character subsets. For example, each letter in a name may be assigned one or more symbols which a target audience might associate with that letter. In another example, each ideograph in a Chinese text (the plurality of characters) could be associated with a registered trademark with visual similarity to the ideograph. In step 602, symbols may be associated with character subsets based on existing or apparent relationships or associations—such as visual similarities, phonetic similarities, common initial characters or sounds, or common target audience associations—between each character subset and each corresponding symbol.

Step 602 may be implemented before or after step 601. For example, one may first assign symbols to a range of potential character subsets. One may then divide the selected plurality of characters into character subsets to which symbols already have been assigned. Alternatively one may select a plurality of characters, then divide it into character subsets, and then assign symbols to the character subsets.

Step 603 of the preferred embodiment depicted in FIG. 6 comprises generating a message comprising the symbols associated with each of the character subsets. Step 603 follows steps 601 and 602 and converts the plurality of characters into a corresponding symbol message. The associated symbols are substituted for the corresponding character subsets, thus yielding a symbol message.

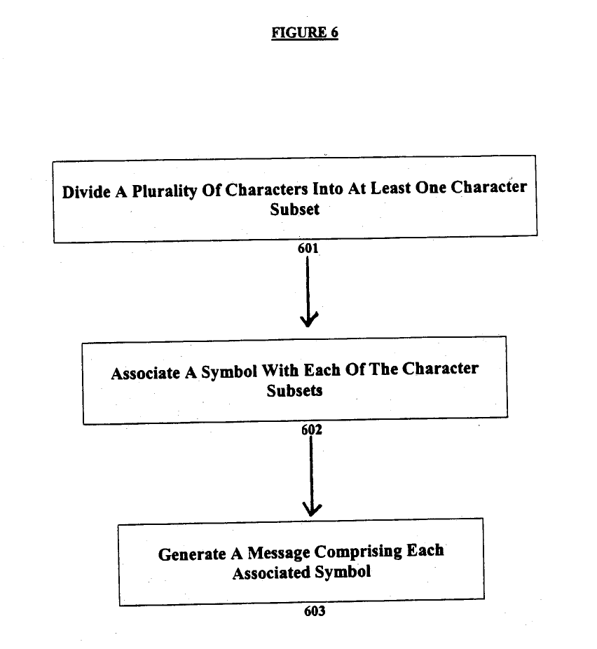

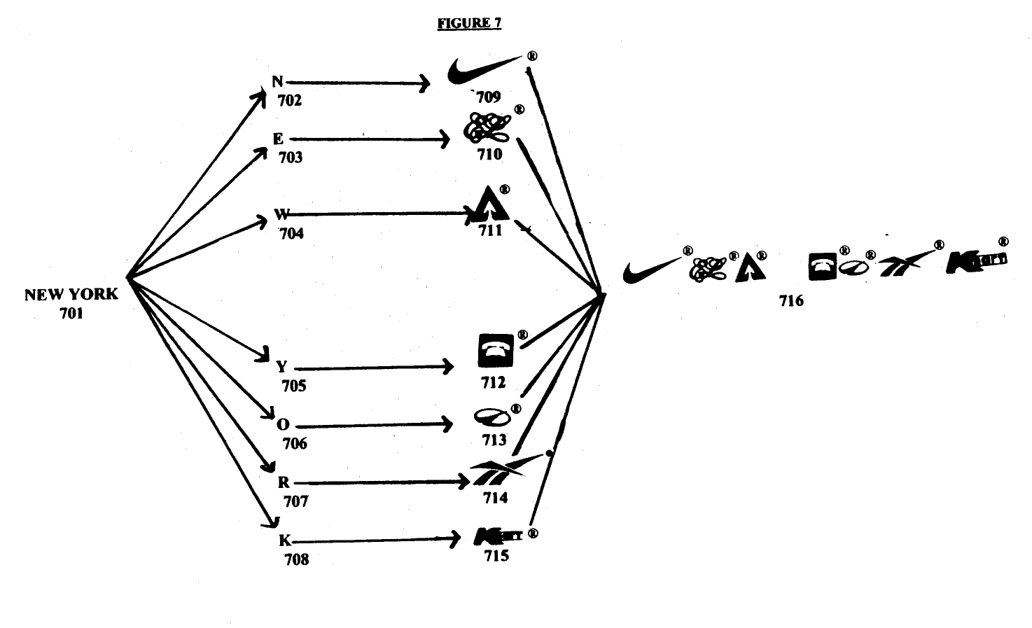

FIG. 7 depicts an example of the embodiment depicted in FIG. 6. In the example depicted in FIG. 7, the plurality of characters 701 is “NEW YORK.” The plurality of characters 701 is divided into seven character subsets 702, 703, 704, 705, 706, 707, and 708: “N,” “E,” “W,” “Y,” “O,” “R,” and “K,” respectively. Each character subset 702, 703, 704, 705, 706, 707 and 708 is associated with a respective symbol 709, 710, 711, 712, 713, 714 and 715. In this example, each of the symbols are registered trademarks, and the character subsets and symbols are associated because the first letter of the brand name consumers associate with each symbol is the same as the corresponding character subset. Other types of associations are described in this specification and would be apparent to one of skill in the art in view of this specification. As depicted in FIG. 7, the symbol message 716 is generated by combining, in order, the associated symbols 709, 710, 711, 712, 713, 714 and 715.

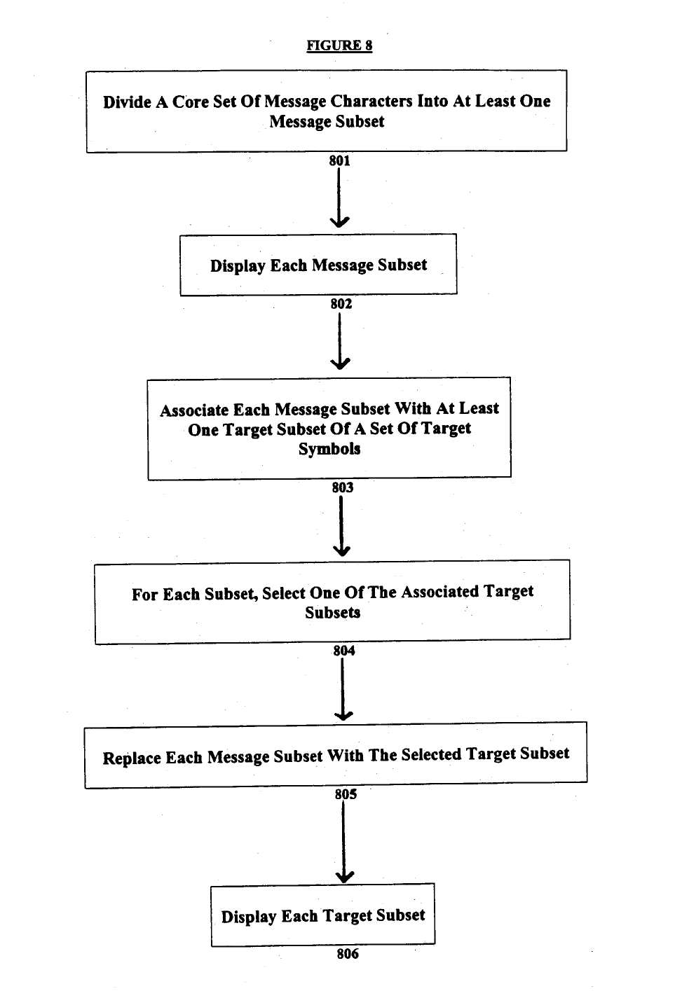

FIG. 8 depicts a flow chart of another embodiment of the method of the present invention. The embodiment depicted in FIG. 8 comprises six steps for generating a symbol message:

Divide A Core Set Of Message Characters Into At Least One Message Subset step 801;

Display Each Message Subset step 802;

Associate Each Message Subset With At least One Target Subset Of A Set of Target Symbols step 803;

For Each Subset, Select One Of The Associated Target Subsets step 804;

Replace Each Message Subset With The Selected Target Subset step 805; and

Display Each Selected Target Subset step 806.

Step 801 comprises dividing a core set of message characters into at least one message subset. The core set of message characters may be all or part of a message, and each message subset may be all or part of the core set of message characters. For example, if a message is a sentence, the core set of message characters might be a word or a phrase of the sentence, or the entire sentence. If the core set of message characters is a word, a message subset might be a letter, a group of letters, a syllable, or the entire word. The message characters and message subsets may comprise alphanumeric characters, phonemes, words, ideographs, or any other visual mark.

Step 802 of the embodiment depicted in FIG. 8 occurs after step 801 and involves displaying each resulting message subset. Display of each message subset shows and confirms how the core set of message characters has been divided.

Step 803 associates each message subset with at least one target subset of a set of target symbols. For example, if a message subset is a phoneme, one or more target symbols associated by a target audience with company names beginning with the same phonetic sound as the phoneme might be associated with the message subset. The set of target symbols may be a closed set, or it may be an open set, for example, all registered trademarks. Step 803 may be implemented before or after either or both of steps 801 and 802. Other ways to generate message subsets and target subsets of target symbols, and to associate message subsets with target subsets, are described in this specification and would be apparent to one of skill in the art in view of this specification.

Step 804 follows, or occurs at the same time as, step 803. Step 804 involves selecting one corresponding target subset for each message subset. For example, if five symbols are associated with one message subset, one of those five symbols would be selected to replace the corresponding message subset.

Step 805 follows steps 801 through 804 and comprises replacing each message subset with the target subset selected for the message subset in step 804. Step 805 converts the core set of message characters into a corresponding symbol message core.

Step 806 follows step 805 and involves the display of each selected target subset. Step 806 may involve the display of one associated target subset for each message subset, or it may involve the display of all associated target subsets for each message subset.

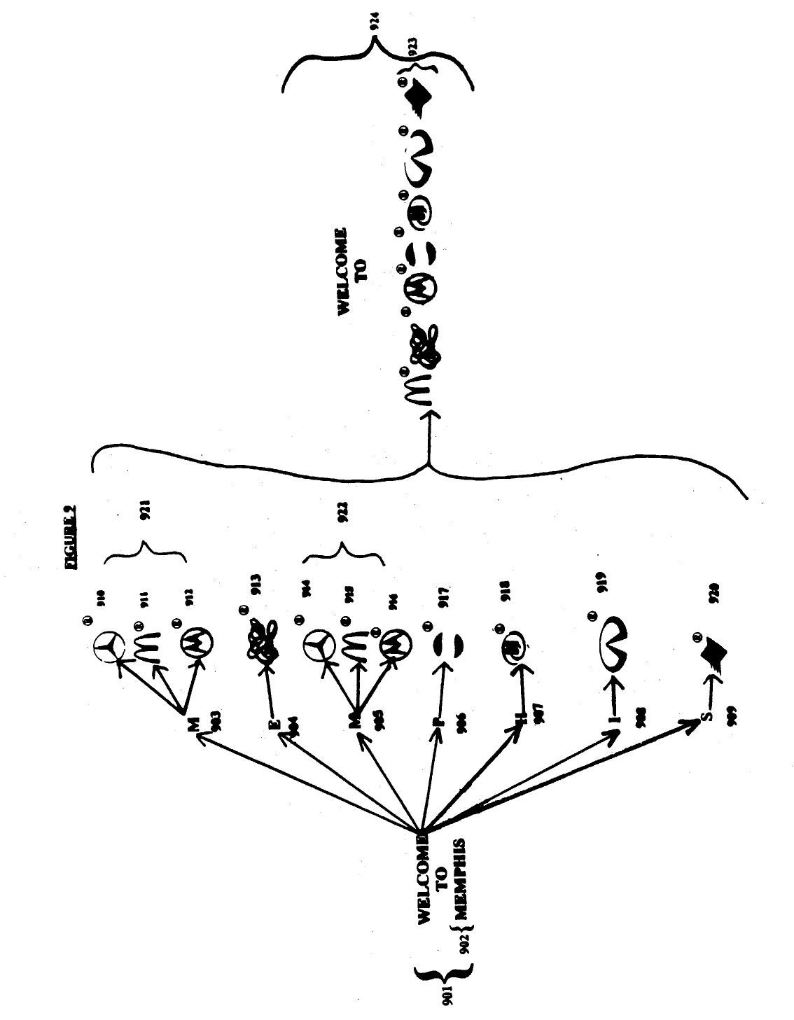

FIG. 9 depicts an example of the embodiment depicted in FIG. 6. The message 901 in this example is “WELCOME TO MEMPHIS.” The core set of message characters 902 in this example is “MEMPHIS.” The core set of message characters 902 is divided into message subsets 903, 904, 905, 906, 907, 908, and 909: “M,” “E,” “M,” “P,” “H,” “I,” and “S.” and each message subset is displayed.

As depicted in FIG. 9, message subset 903 is associated with a target subset 921 including target symbols 910, 911 and 912; message subset 904 is associated with a target subset 913 including target symbol 913; message subset 905 is associated with target subset 922 including target symbols 914, 915 and 916; message subset 906 is associated with target subset 917 including target symbol 917; message subset 907 is associated with target subset 918 including target symbol 918; message subset 908 is associated with target 919 including target symbol 919; and message subset 909 is associated with target 920 including target symbol 920. The target subsets depicted in FIG. 9 were drawn from an open-ended target set of symbols comprising all proprietary symbols. In this example, all of the target symbols are registered trademarks. Target symbols 911, 913, 916, 917, 918, 919, and 920 are then selected, one from each respective target subset 921, 913, 922, 917, 918, 919, and 920, to correspond respectively to each message subset 903, 904, 905, 906, 907, 908, and 909. Each message subset 903, 904, 905, 906, 907, 908, and 909 is then replaced with the corresponding selected target subset, and result 923 is displayed. In the embodiment depicted in FIG. 9, the final symbol message 924 is also displayed.

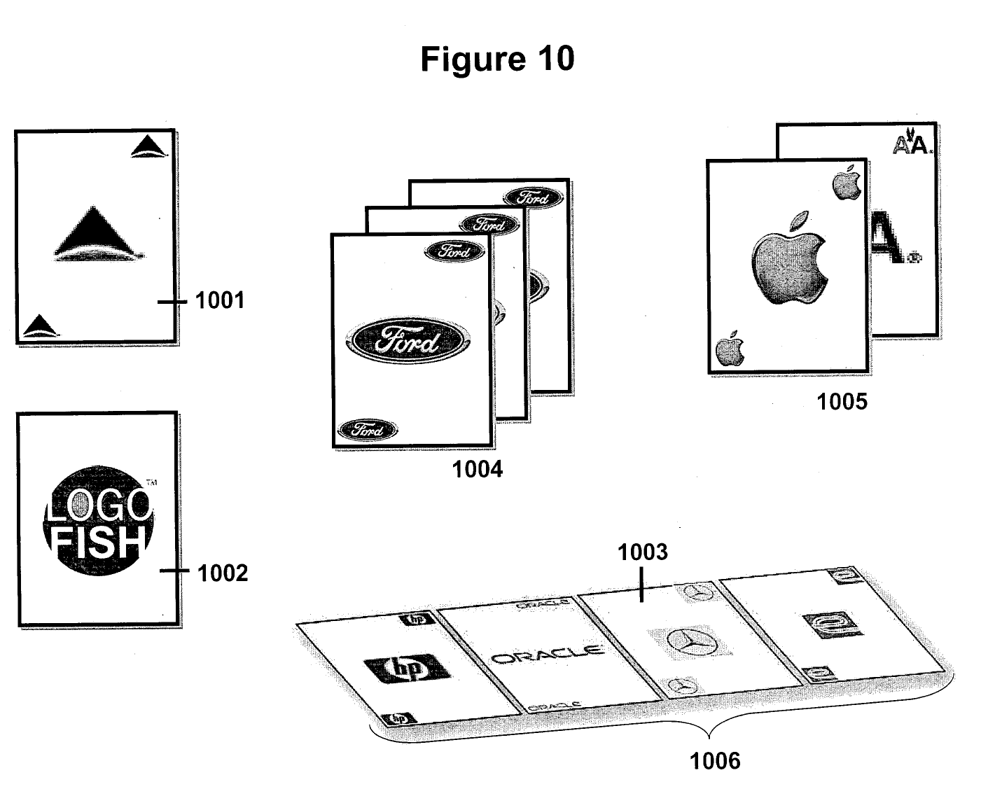

FIG. 10 depicts an embodiment of the present invention that is an apparatus for playing games using symbol messages generated in the manner described above. In FIG. 10, the apparatus comprises a set of playing cards. The playing cards are rectangular in this embodiment. In other embodiments, the playing cards can be a variety of geometric or other shapes.

In the embodiment depicted in FIG. 10, the playing cards have a front side 1001 and a back side 1002. The front side of each card depicts one or more symbols, each symbol coming from the group consisting of trademarks, registered trademarks, service marks, registered service marks, well-known marks, and other proprietary symbols. The front of each card in this embodiment depicts one symbol. For example, card 1003 depicts the symbol for Mercedes. In other embodiments, each card may depict more than one symbol on its front side.

In alternative embodiments, some playing cards may be blank (i.e., have no symbol on either side), may depict a punctuation mark, may depict a symbol with particular meaning in the game (e.g., a “wildcard” symbol), or may have some other non-proprietary symbol. In embodiments, the majority of cards depict symbols that are trademarks, registered trademarks, service marks, registered service marks, well-known marks or symbols, logos or other proprietary symbols.

In the embodiment in FIG. 10, the apparatus includes rules (not depicted) that suggest grouping cards by (i) commonality of symbol, (ii) commonality of associated alphanumeric characters, phonemes, words, ideographs, or other message subsets associated with symbols, or (iii) ability to form a symbol message made from a symbol from each of the grouped cards. For example, one group of cards 1004 has been grouped because the three cards all depict a registered trademark symbol associated with Ford Motor Co. A second group of cards 1005 has been grouped because the two cards both depict symbols—registered trademark symbols associated, respectively, with Apple Computer, Inc. and American Airlines—associated with the letter “A.” A third group of cards 1006 has been grouped because the cards create a symbol message for the word “HOME,” using the registered trademark symbols respectively associated with Hewlett-Packard Co., Oracle International Corp., Mercedes-Benz, and Enterprise Rent-A-Car Co.

In alternative embodiments, the rules (which may be printed, displayed, recorded or otherwise communicated to players) suggest the incorporation of these grouping concepts in games using playing cards as described in this specification. For example, in one embodiment, the rules may include the following instructions:

(i) each player (e.g., a first player and a second player) is dealt a number of cards, which cards comprise that player's playing hand;

(ii) the remaining cards are placed in a common pile;

(iii) players (e.g., the first player) take turns asking at least one other player (e.g., the second player or the second and third players) whether he or she has one or more cards depicting a selected symbol;

(iv) if the other player(s) (e.g., the second player or the second and third players) has the requested card(s), they must give the requested card(s) to the asking player (e.g., the first player);

(v) if the other player(s) (e.g., the second player or the second and third players) does not have the requested card(s), the asking player (e.g., the first player) must draw a card from the common pile; and

(vi) each player tries to group cards in their hands using the grouping concepts discussed above.

In another embodiment, the rules may include the following instructions, using playing cards described in this specification:

(i) each player is dealt a number of cards making up that player's hand;

(ii) the remaining cards are placed in a common pile;

(iii) the first player takes a card from the common pile;

(iv) the first player then passes a card (which may be either the card selected from the common pile or a card the player already had in his or her hand) to a second player;

(v) the second player then passes a card from the second player's hand to a third player, and so on;

(vi) the last player passes a card from his or her hand to the bottom of the common pile; and

(vii) this process is repeated as players try to group cards in their hands using the grouping concepts discussed above.

In yet other embodiments of the present invention, the rules include rules for playing commonly known card games, such as Go Fish or Gin Rummy, using the grouping techniques described above.

Alternative embodiments of the present invention include methods of playing games using cards depicting symbols that are trademarks, registered trademarks, service marks, registered service marks, well-known marks, or other proprietary symbols. In some preferred embodiments, cards are grouped by (i) commonality of symbol, (ii) commonality of associated alphanumeric characters, phonemes, words, ideographs, or other message subsets associated with symbols, or (iii) ability to form a symbol message. One alternative embodiment of the present invention is a method of playing card games using the grouping rules described above. Alternative embodiments include, for example, methods for playing Go Fish or Gin Rummy wherein cards are grouped by (i) commonality of symbol, (ii) commonality of associated alphanumeric characters, phonemes, words, ideographs, or other message subsets associated with symbols, or (iii) ability to form a symbol message.

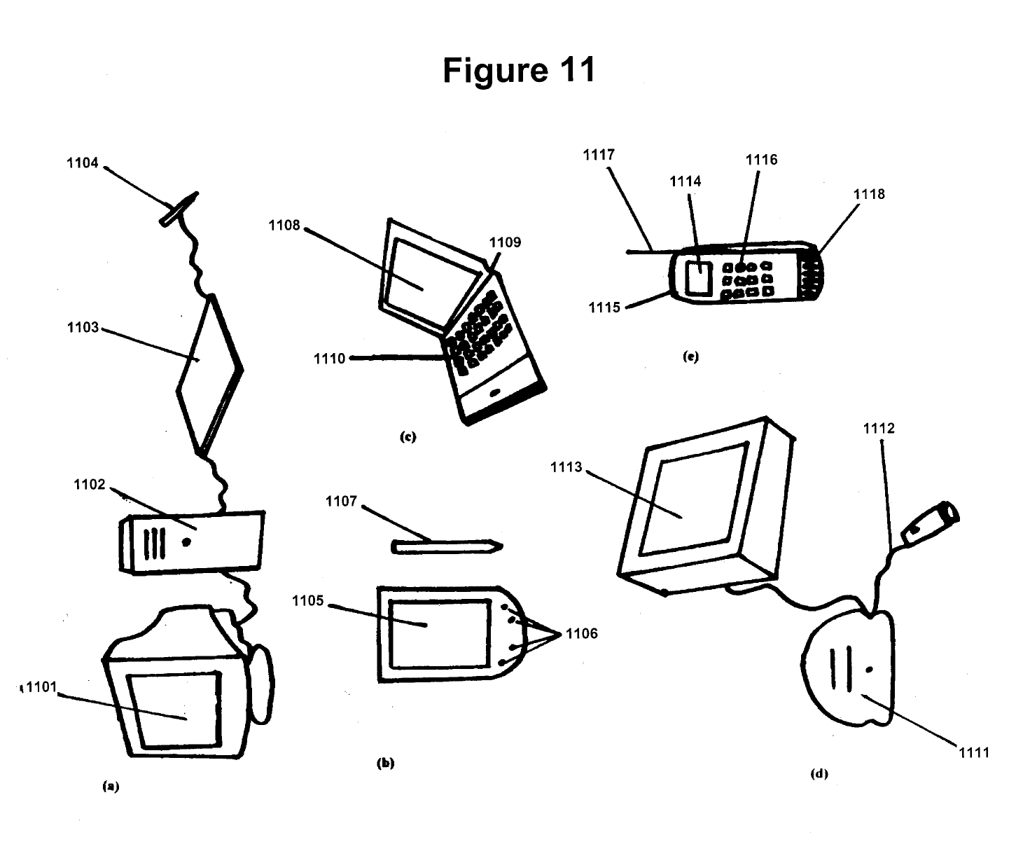

Other embodiments of the present invention include apparatuses configured for generating symbol messages or grammars or playing games according to the present invention. FIG. 11 depicts five alternative embodiments. In each embodiment depicted in FIG. 11, the apparatus comprises an input device configured to receive a message, a visual display, a memory device configured to receive and store information, and a microprocessor in communication with the memory device, the input device, and the visual display.

In the embodiment depicted in FIG. 11(a), an example of a desktop computer, the input device is stylus 1104 and pad 1103 for handwriting and drawing recognition and entry; the visual display is monitor 1101; and tower 1102 houses a microprocessor and a memory, which are in communication with each other and pad 1103 and monitor 1101.

In the embodiment depicted in FIG. 11(b), an example of a personal digital assistant, the input device comprises screen display 1105, buttons 1106 and stylus 1107; the visual display is screen display 1105; and the personal digital assistant houses a microprocessor and a memory, which are in communication with each other and buttons 1106 and screen display 1105.

In the embodiment depicted in FIG. 11(c), an example of a laptop computer, the input device is keyboard 1110; the visual display is screen 1108; and laptop 1109 houses a microprocessor and a memory, which are in communication with each other and keyboard 1110 and screen 1108.

In the embodiment depicted in FIG. 11(d), another example of a desktop computer, the input device is microphone 1112; the visual display is screen 1113; and chassis 1111 houses a microprocessor (including voice recognition and generation hardware and software) and a memory, which are in communication with each other and microphone 1112 and screen 1113.

In the embodiment depicted in FIG. 11(e), an example of a wireless telephone, the input devices are keypad 1116, microphone 1118, and receiver/antenna 1117; the visual display is screen 1114; and the wireless telephone 1115 houses a microprocessor and a memory, which are in communication with each other and keypad 1116, microphone 1118, receiver/antenna 1117, and screen display 1114.

In an embodiment, the apparatus according to the present invention is configured to divide a message into at least one message subset, to associate symbols (optionally symbols that are trademarks, registered trademarks, service marks, registered service marks, or well-known marks) with each message subset, and to replace each message subset with the associated symbols.

In an alternative embodiment, the apparatus according to the present invention is configured to divide a plurality of characters into at least one character subset, to associate symbols with each character subset, and to generate messages comprising the associated symbols.

In another embodiment, the apparatus according to the present invention is configured to divide a core set of message characters into at least one message subset, to associate each message subset with at least one target symbol, to prompt the selection of one of the associated target symbols for each message subset, to replace each message subset with the selected target symbol, and to show each message subset and each selected target symbol.

In another embodiment, the apparatus according to the present invention is configured to draw from a set of symbols, to generate an association between subsets of a set of characters and subsets of the set of symbols, and to generate a lexicon comprising such associations.

In another embodiment, the apparatus according to the present invention is configured to implement the method of playing card games described above. In one embodiment, the apparatus is configured to (i) display playing cards depicting symbols, (ii) receive instructions for changing the association of one or more of the playing cards from one player to another, (iii) implement such instructions; (iv) display results of implementing such instructions; and (v) confirm grouping of a set of cards associated with a player in the manner described above.

More generally, available technology and information known in the art may be used to fabricate program and control components or devices capable of performing, or facilitating the performance of, the requisite tasks or steps for implementing the methods of the present invention. These components or devices include without limitation computers, computerized devices, cellular telephones, hand-held computerized devices, microprocessors, computerized devices, disk drives, floppy disks, CD-ROMs, CDs, and other computerized devices.

It will be apparent to those skilled in the art that various modifications can be made to this invention of methods and apparatus for generating symbol messages and grammar without departing from the scope or spirit of the invention or of the claims. It is also intended that the present invention and appended claims cover modifications, variations and equivalents of the methods and apparatus for generating symbol messages and grammar of the present invention.

What is claimed is:

1. An apparatus for playing a game comprising a plurality of cards, wherein the front of each of card depicts a symbol from the group consisting of trademarks, registered trademarks, service marks, registered service marks, and well-known marks.

2. The apparatus of claim 1 wherein each symbol is associated with an alphanumeric character, a phoneme, a word, or an ideograph.

3. The apparatus of claim 2 wherein the associated alphanumeric characters, phonemes, words, or ideographs comprise an alphabet.

4. The apparatus of claim 1 further comprising rules suggesting grouping cards
by commonality of symbol,
by commonality of alphanumeric characters, phonemes, words, or ideographs associated with the symbols, or
by ability to form a symbol message comprising a set of symbol message subsets, wherein
the symbol message is associated with a message and
the symbol depicted on the front of each grouped card is associated with one of the set of symbol message subsets.

5. The apparatus of claim 4 wherein the message comprises a word or a phrase.

6. The apparatus of claim 4 wherein the each of the symbol message subsets comprises an alphanumeric character, a phoneme, a word, or an ideograph.

7. The apparatus of claim 4 further comprising rules suggesting that
a first player and a second player respectively receive a first playing hand and a second playing hand, wherein each playing hand comprises a group of at least one of the cards;
a common pile be created, wherein the common pile comprises cards remaining after the first and second playing hands have been formed;
the first player ask the second player whether the second playing hand includes one of the plurality of cards depicting a selected symbol;
if the second playing hand includes one of the plurality of cards depicting the selected symbol, the second player give the one of the plurality of cards depicting the selected symbol to the first player, but
if the second playing hand does not include one of the plurality of cards depicting the selected symbol, the first player draw one of the cards from the common pile; and
the first player and the second player respectively seek to group cards in the first playing hand and the second playing hand.

8. The apparatus of claim 7 wherein the message comprises a word or a phrase.

9. The apparatus of claim 7 wherein each of the symbol message subsets comprises an alphanumeric character, a phoneme, a word, or an ideograph.

10. The apparatus of claim 4 further comprising rules suggesting that
a first player and a second player respectively receive a first and second playing hand, wherein each playing hand comprises a group of at least one of the cards;
a common pile be created, wherein the common pile comprises cards remaining after the first and second playing hands have been formed;
the first player take one card from the common pile and include it in the first playing hand;
the first player pass a card from the first playing hand to the second player;
the second player include the passed card in the second playing hand;
the second player discard one card from the second playing hand; and
the first and second players seek to group, respectively, cards in the first and second playing hand.

11. The apparatus of claim 10 wherein the message comprises a word or a phrase.

12. The apparatus of claim 11 wherein each of the symbol message subsets comprises an alphanumeric character, a phoneme, a word, or an ideograph.

13. A method for playing a game using a plurality of cards wherein each of the plurality of cards depicts a symbol from the group consisting of a trademark, a registered trademark, a service mark, a registered service mark, and a well-known mark, the method comprising grouping cards
by commonality of symbol,
by commonality of alphanumeric characters, phonemes, words, or ideographs associated with the symbols, or
by ability to form a symbol message comprising a set of symbol message subsets, wherein
the symbol message is associated with a message,
the symbol depicted on the front of each grouped card is associated with one of the set of symbol message subsets.

14. The method of claim 13 wherein the message comprises a word or a phrase.

15. The method of claim 13 wherein each of the symbol message subsets comprises an alphanumeric character, a phoneme, a word, or an ideograph.

16. The method of claim 13 further comprising
distributing a first playing hand and second playing hand, respectively, to a first player and a second player, wherein each playing hand comprises a group of at least one card;
creating a common pile, wherein the common pile comprises cards remaining after the first and second playing hands have been distributed;
the first player asking the second player whether the second playing hand includes one of the plurality of cards depicting a selected symbol;
if the second playing hand includes one of the plurality of cards depicting the selected symbol, the second player giving the one of the plurality of cards depicting the selected symbol to the first player, but
if the second playing hand does not include one of the plurality of cards depicting the selected symbol, the first player drawing one of the cards from the common pile; and
the first player and the second player respectively seeking to group cards in the first playing hand and the second playing hand.

17. The method of claim 16 wherein the message comprises a word or a phrase.

18. The method of claim 16 wherein each of the symbol message subsets comprises an alphanumeric character, a phoneme, a word, or an ideograph.

19. The method of claim 13 further comprising
distributing a first playing hand and second playing hand, respectively, to a first player and a second player, wherein each playing hand comprises a group of at least one card;
creating a common pile, wherein the common pile comprises cards remaining after the first and second playing hands have been distributed;
the first player taking one card from the common pile and including it in the first playing hand;
the first player passing a card from the first playing hand to the second player;
the second player including the passed card in the second playing hand;
the second player discarding one card from the second playing hand; and
the first and second players seeking to group, respectively, cards in the first and second playing hand.

20. The method of claim 19 wherein the message comprises a word or a phrase.

21. The method of claim 19 wherein each of the symbol message subsets comprises an alphanumeric character, a phoneme, a word, or an ideograph.

22. An apparatus for playing a game, comprising an input device configured to receive instructions;
a visual display;
a memory device configured to receive and store information; and
a microprocessor in communication with the memory device, the input device, and the visual display;
the apparatus configured to
display each of a plurality of playing cards, wherein each card depicts a symbol from the group consisting of a trademark, a registered trademark, a-service mark, a registered service mark, and a well-known mark;
receive instructions for changing an association of one of the playing cards from a first player to a second player;
implement the instructions;
display the results of implementation of the instructions; and
confirm grouping of a set of cards associated with the first player or the second player
by commonality of symbol,
by commonality of alphanumeric characters, phonemes, words, or ideographs associated with the symbols, or
by ability to form a symbol message comprising a set of symbol message subsets, wherein
the symbol message is associated with a message and
the symbol depicted on the front of each grouped card is associated with one of the set of symbol message subsets.

23. The method of claim 22 wherein the message comprises a word or a phrase.

24. The method of claim 22 wherein each of the symbol message subsets comprises an alphanumeric character, a phoneme, a word, or an ideograph.
